(19) United States
(12) Patent Application Publication
(10) Pub. No.: US 2020/0157404 A1
(43) Pub. Date: May 21, 2020

(54) Capsule-type expansion body based on geothermal heating, and method thereof for plugging formation leakage and improving formation bearing capacity

(71) Applicant: SOUTHWESTERN PETROLEUM UNIVERSITY, Chengdu (CN)

(72) Inventors: Tiejun Lin, Chengdu (CN); Yang Liu, Chengdu (CN); Zhanghua Lian, Chengdu (CN); Hao Yu, Chengdu (CN); Qiang Zhang, Chengdu (CN); Yisheng Mou, Chengdu (CN); Hao Chen, Chengdu (CN); Zhaoyang Li, Chengdu (CN); Xiaomin Bao, Chengdu (CN); Jinchao Cao, Chengdu (CN)

(73) Assignee: SOUTHWESTERN PETROLEUM UNIVERSITY

(21) Appl. No.: 16/773,989

(22) Filed: Jan. 28, 2020

Related U.S. Application Data
(63) Continuation of application No. PCT/CN2018/112430, filed on Oct. 29, 2018.

(30) Foreign Application Priority Data
Aug. 13, 2018 (CN) 201810914723.0

(51) Int. Cl. C09K 8/42

(52) U.S. Cl. CPC C09K 8/426; E21B 33/13

(57) ABSTRACT

A capsule-type expansion body based on geothermal heating, and a method thereof for plugging formation leakage and improving formation bearing capacity are provided. The capsule-type expansion body includes a capsule shell, and a liquid or solid temperature-controlled expansion material, which circulates with a drilling fluid and enters formation fractures and pores around a well and at a long distance. After heating to a certain temperature range with formation temperature, it expands rapidly and greatly to adaptively plug various types of leakage formations with elastic deformation and improve the formation bearing capacity. The capsule-type expansion body is divided into physical gasification type or chemical decomposition reaction type according to expansion principles of the liquid or solid temperature-controlled expansion materials. It maintains an unexpanded state during ground transportation and circulation in a wellbore at a relatively low-temperature.

### CROSS REFERENCE RELATED APPLICATION

This is a Continuation Application of the International Application PCT/CN2018/112430, filed Oct. 29, 2018, which claims priority under 35 U.S.C. 119(a-d) to CN 201810914723.0, filed Aug. 13, 2018.

### BACKGROUND OF THE PRESENT INVENTION

### Field of Invention

The present invention relates to a technical field of drilling and completion of oil-gas wells or geothermal wells, and more particularly to a capsule-type expansion body based on geothermal heating for effectively plugging complex leaking formation, and a plugging method as well as application thereof.

### Description of Related Arts

There is no effective and reliable technology so far to solve lost circulation problems (mainly referred to as malignant leakage) and related complicated downhole problems. “Malignant leakage” is mainly manifested by the large amount of drilling fluid leakage and it is difficult to be effectively plugged, which is usually plugged without regarding time, frequency, leakage amount and method. The conventional plugging technology is relatively rough and complicated, still based on experience and lacks effective plugging materials, which has not formed a series of supporting technologies, and cannot simultaneously meet the 7 requirements of “flowing, flushing, holding, discharging, filling, resisting and separating”.

Conventionally, the plugging materials have the following disadvantages. the deformability during the plugging process is poor. Particles, which are slightly larger than the leakage layer pores and fractures or do not match the shapes of the leakage layer pores and fractures, are difficult to enter. Such particles will accumulate at the surface and will not penetrate deep into the leakage layer. Second, the plugging materials have no or little expansibility, which unstably stay in the leakage layer under the effect of external forces. Third, the plugging materials have strong dependence on the formation pores or fractures. If size of the plugging agent does not match the pore throat diameter of the leakage formation, the plugging effect will not be sufficient. Instead, the plugging agent will simply form a seal outside the well wall, which has poor adaptability for leakage preventing and plugging. Fourth, the plugging materials have a great impact on the rheological properties of drilling fluids. Therefore, a large number of indoor and field evaluation tests are required during adding, which increases costs and drilling risks. Fifth, the plugging materials have poor acid solubility in the later stages, which has potential damage to the reservoir. Sixth, plugging ability and compressive strength for micro-fractured formation are weak, wherein leakage may happen again due to the high pressure difference during drilling. The plugging materials are not suitable for the leakage layer with both leakage and reservation features.

There are many researches and patent applications for plugging materials all over the world, mainly concentrated in USA. For example, May 2002 U.S. Pat. No. 6,395,186B1 proposed a method and device for increasing the flow rate of continuous plugging agents. The innovation is a liquid-leakage plugging agent-filter unit with a carrier liquid and coalesced solid particles.

Referring to November 2006 U.S. Pat. No. 7,134,496B2, single-phase microemulsion improves the removing ability of filter cake formed during drilling with inverse emulsion. The single-phase microemulsion removes oil and solids from sedimentary filter cake. The microemulsion can also be used for solubilizing the filter cake bridging particles.

August 2012 U.S. Pat. No. 8,252,729B2 proposed a method and a composition using a drilling fluid, wherein the drilling fluid comprises sub-micron precipitated barite with an average particle size of less than 1 um. Sub-micron precipitated barite has good particle size distribution. At least 10% of the precipitated barite is less than 0.2 um in diameter and at least 50% is less than 0.3 um. The method of precipitating barite can increase different plugging functions and reduce drilling fluid loss.

July 2015 U.S. Pat. No. 8,783,352B2 proposed a method for improving the stability of shale formations with water-based drilling fluid, and disclosed a nano-particle composition of any shape with an effective diameter of 1-500 nm, including subclasses such as nano-powders, nano-clusters and nano-crystals. The nano-particles can also improve stability in drilling fluid by surface modification, and change of surface charge density of the nano-particles improves the shale stability.

March 2018 U.S. Pat. No. 9,910,026B2 proposed a composite material tracer including a metal matrix model which is mainly composed of a nano-material module and a metal module. The thickness is about 1.0 nm to 200 um, which can enter into different formations with the drilling fluid and be embedded in fractures to plug the well bottom.

In summary, plugging agent patents out of China mainly change the size of drilling fluid particles, and use bridging methods to improve plugging functions.

Chinese patent applications mainly improve the composition of the plugging materials to reduce the leakage of drilling fluid, thereby increasing the plugging capacity. For example, Chinese patent application CN 201110047689.X proposed a plugging agent with controllable expansion, which has a relatively high processing cost and a poorly controlled formulation ratio. Raw materials are all commercially available and must be inspected strictly according to industry standards or corporate standards when purchasing, wherein only qualified ones can be used. Such plugging agent is difficult to promote.

Chinese patent application CN 201110088331.1 proposed a broad-spectrum deformable and drilling leakage-proof plugging agent. The plugging agent is highly efficient, does not depend on the pore and fracture size of the leakage layer, has a high acid solubility rate, and can be used for drilling leakage plugging of permeabe-type and fracture-type non-reservoirs and reservoirs.

Chinese patent application CN 201110047689.X disclosed a controllable expanding plugging agent and a preparation method thereof. The obtained plugging agent has a certain deformability and strength. However, the chemical products used by the plugging agent are not eco-friendly and the production cost is high.

Chinese patent application CN 201210548442.0 disclosed a degradable underground plugging material belonging to the technical field of material preparation. After being used for a certain period of time, it will be partially dissolved automatically, which is beneficial to environmental protection.

Chinese patent application CN 201210015064.X proposed a five-constant polymer plugging material. After exothermic chemical reaction, the two substances expand and eventually cure, so as to improve water flow plugging, space filling, and bond strength of the material.

Chinese patent application CN 201310727758.0 can effectively resist the dilution of formation water, which further enhances the strength of the plugging layer, and establishes an effective barrier for subsequent cement sealing.

Chinese patent application CN 201310667534.5 proposed a delayed-expanding gel material, which needs large consumption amount and high cost. Furthermore, it is recommended to use an arbitrary ratio of bridging agent and tamping agent, which is regardless of gradation and concentration ratio, and it is easy to cause material waste and low plugging success rate.

Chinese patent application CN 201310510834.2 disclosed a micro-nano plugging material for micro-fractures during drilling and a preparation method thereof. The plugging material is composed of 100 to 200 parts of paraffin nanoemulsion and 200 to 400 parts of composite ultrafine calcium carbonate.

Chinese patent application CN 201510411556.4 disclosed a controllable expansion speed of a controllable expanding agent, which has good deformability and adaptability, so as to reduce the permeability of the plugging layer, enhance the strength of the plugging layer, and improve the pressure bearing of the plugging layer. It is low in cost, non-toxic, harmless, pollution-free, green and eco-friendly.

Chinese patent application CN 201510696183.X disclosed a high-expansion plugging agent with high strength and self-expanding functions for high-strength plugging, which solves the problem that ordinary plugging agents cannot reside. At the same time, the plugging agent has good solubility during preparation and good fluidity during injection, which is convenient and safe in construction.

Chinese patent application CN 201710301790.0 disclosed a water-absorbing expanding plugging agent. The composition and use of the plugging agent consider different composition of the plugging agent under different fracture openings and consider particle size gradation and concentration of inert materials to reduce material waste, which provides high success rate of plugging and is eco-friendly.

Chinese patent application CN 201710164944.6 proposed a temperature-sensitive expansion microcapsule gas channeling-preventing agent and a gas channeling-preventing cement slurry system. Through preparing different components such as oil well cement, fluid loss reducing agent, dispersant, gas channeling-preventing agent, retarder and defoamer density regulator, the gas channeling-preventing cement slurry system can be obtained, which can effectively compensate for the shrinkage of cement stone volume, seal formation fluids to prevent channeling, prevent annulus pressure, and extend service lives of oil wells. The system is mainly aimed at improving the quality of well walls in the early stage of well cementing, which does not involve the function of entering the formation with a drilling fluid and plugging the formation, and does not involve measures to solve the pollution caused to the formation as well as benefit to the later stage of well cementing.

Comprehensive analysis of the above patents and the conventional plugging problems shows that some plugging agents cannot fully meet the above 7 requirements, and the conventional plugging methods are relatively ineffective. For example, during plugging, fiber and resin mainly get into the pores near the wall surface and are difficult to enter the location far from the well wall, which are easy to be flushed away and drained when the wellbore drilling fluid undergoes pressure fluctuation and flow velocity change, leading to loss of the plugging effect, Emulsion-based plugging materials have small particles which will go too deep into the wall fracture, which are difficult to be discharged from the pores in the later stages, wherein oil and gas production efficiency and yield in the later stages are lowered, and the effect of formation temperature and pressure cannot be fully utilized. Secondly, the conventional plugging agents are difficult to plug, and the adaptability is not strong. Other types of plugging agents (such as walnut shell type) are used to plug small fractures, but the walnut shell type plugging agent cannot deform according to the pore size, and is difficult to plug large fractures. Generally speaking, some of the above-mentioned plugging agents are very shallow when plugging, and some are very deep. They cannot effectively plug the pores of the formation, and the cost is high. The processing technology and on-site construction technology are difficult, and the process formula is complicated and the cost is relatively high.

The present invention chooses a capsule-type expansion body plugging material that can both degrade and produce large elastic deformation, which adapts to different pore diameters and undergoes elastic deformation. The capsule-type expansion body material can be degraded to produce gaseous materials which are discharged with drill fluid and circulating working. No chemical reaction occurs in shallow wells due to low temperatures. The chemical reaction occurs only when the formation temperature is high, which fully uses the gradient change of the geothermal heat.

### SUMMARY OF THE PRESENT INVENTION

An object of the present invention is to provide a capsule-type expansion body based on geothermal heating and application thereof.

Accordingly, in order to accomplish the above objects, the present invention provides a capsule-type expansion body based on geothermal heating, comprising:

a capsule shell, and

a liquid or/and solid temperature-controlled expansion material;

wherein the capsule shell is a capsule-type expansion body material with strong alkali resistance;

the liquid or/and solid temperature-controlled expansion material is a temperature-controlled expansion material a or/and a temperature-controlled expansion material b.

Preferably, the liquid or/and solid temperature-controlled expansion material is the temperature-controlled expansion material a, which is a liquid or solid substance A at normal temperature and pressure; an expansion principle is a physical gasification or sublimation reaction: A_{(liquid or solid)}≙A_{(gas)}↑; after the geothermal heating, the substance A reaches a gasification or sublimation reaction temperature and transforms to a gas, in such a manner that the capsule-type expansion body undergoes a large volume expansion; the gasification or sublimation reaction temperature of the substance A is relatively low, and is suitable for leakage formations of deep wells with a high temperature of 80-150° C. In the present invention, the temperature-controlled expansion material a uses liquid SiCl₄ or Br₂ as a temperature-controlled material, which vaporizes and rapidly expands when a temperature exceeds 60-70° C.

Preferably, the liquid or/and solid temperature-controlled expansion material is the temperature-controlled expansion material b, which is a solid single substance or mixture B; an expansion principle is a material decomposition or chemical reaction: B≙C↑+D; after the geothermal heating, the substance or mixture B reaches a material decomposition or chemical reaction temperature and releases a large amount of gas C, in such a manner that the capsule-type expansion body undergoes large volume expansion; the material decomposition or chemical reaction temperature of the substance or mixture B is relatively high, and is suitable for leakage formations of deep wells with a super-high or ultra-high temperature of 150-450° C. In the present invention, the temperature-controlled expansion material b is nitrate substances chemically decomposed at 150-250° C.; basic carbonate substances and sodium nitrite chemically decomposed at 250-350° C.; or ammonium sulfate, ferrous sulfate, potassium chlorate substances chemically decomposed 350-450° C.

Preferably, an external diameter of the capsule-type expansion body is 0.1-10 mm. Small-diameter expansion bodies can enter smaller fractures and plug formations at a long distance. Large-diameter expansion bodies can enter larger fractures and pores and plug formations at a long distance. The expansion bodies with different scales of the external diameter can be formulated for effective formation leakage plugging.

The capsule-type expansion body of the present invention is suitable for leakage formations with different geothermal gradients, and can be applied to deep wells, super-deep wells fracture-type, hole-type formation oil-gas wells or geothermal wells with a formation temperature of 80-450° C. The capsule-type expansion bodies with one or two expansion principles are selected according to formation plugging requirements and geothermal heat. The temperature-controlled expansion materials can be one or two gasification materials that do not undergo a chemical reaction, or a single substance or a mixture that undergoes a chemical reaction at different temperatures.

The present invention also provides a method for plugging formation leakage and improving formation bearing capacity with a capsule-type expansion body, comprising steps of: when the formation leakage occurs, mixing the capsule-type expansion body with a drilling fluid or a gas circulation medium according to a proportion; circulating the capsule-type expansion body in a drill string with the drilling fluid or the gas circulation medium, in such a manner that the capsule-type expansion body enters fractures and pores of a formation at a long distance around a well under a pressure difference; continuously heating the capsule-type expansion body with formation temperature to reach a physical-chemical reaction temperature, so as to rapidly expand a volume of the capsule-type expansion body by 3-10 times; and adaptively plugging various types of leakage formations with elastic deformation of the capsule-type expansion body.

Preferably, the capsule-type expansion body accounts for 3%-8% of a volume of the drilling fluid, which is harmlessly compatible with the drilling fluid and does not change drilling processes.

Compared with the prior art, technical effects of the present invention are as follows.

(1) The capsule-type expansion body used can simultaneously meet the 7 requirements of “flowing, flushing, holding, discharging, filling, resisting and separating”, which are important properties related to well wall stability, damage and protection of oil layer; and improvement of the formation bearing capacity.

(2) When a circulating temperature of the drilling fluid is low, the capsule-type expansion body will not expand and will not affect the drilling operation.

(3) The formation temperature is fully used for chemical reactions, so as to expand from small particles to large particles with high expansion rate, wherein no other external factors are needed, achieving simple process, simple structure and manufacturing of expansion particles, and low cost.

(4) The capsule-type expansion body can easily enter the pores of the formation, no matter the fractured formations is near or far from well walls, and then the pores are easily plugged.

(5) The shell of the capsule-type expansion body is degradable after expansion (degrade after a certain period of time), and releases gas which is quickly discharged without clogging the formation, thereby restoring formation permeability, not affecting productivity, and not causing damage to the formation.

(6) The shell of the capsule-type expansion body can degrade, rupture and release gas and residual expansion materials after the high formation temperature is sustained for a certain period of time, thereby removing formation plug and restoring formation permeability.

(7) The capsule-type expansion body quickly changes from small particles to large particles to plug the leakage formation without t additional operations. It has the advantages of fast and effective plugging, being self-adaptive, long distance, and removable.

(8) During mixing with the drilling fluid, the capsule-type expansion body will not deform and will not affect the components of the drilling fluid. It is harmlessly compatible with the drilling fluid and does not change drilling processes, and keeps unexpanded while circulating in a wellbore with a relatively low temperature.

### BRIEF DESCRIPTION OF THE DRAWINGS

In order to more clearly explain the embodiments of the present invention or the technical solutions in the prior art, the drawings used in the description of the embodiments or the prior art will be briefly introduced below. Obviously, the drawings in the following description are merely some embodiments of the present invention. For those of ordinary skill in the art, other drawings can be obtained based on these drawings without paying creative effort.

FIG. 1 is a cross-sectional view of a method and process for plugging formation leakage and improving formation bearing capacity with a capsule-type expansion body based on geothermal heating;

FIG. 2 illustrates a physical gasification reaction of a capsule-type expansion body material of the method and the process for plugging the formation leakage and improving the formation bearing capacity with the capsule-type expansion body based on the geothermal heating;

FIG. 3 illustrates a chemical decomposition reaction of the capsule-type expansion body material of the method and the process for plugging the formation leakage and improving the formation bearing capacity with the capsule-type expansion body based on the geothermal heating.
1-drill string, 2-drilling fluid or gas circulating medium, 3-capsule-type expansion body, 4-well wall, 5-leakage formation, 6-formation fracture, 7-small fracture, 8-large fracture, 9-expanded expansion body, 10-capsule-type expansion body shell, 11-physical gasification substance A, 12-chemical decomposition substance B, 13-expanded expansion body shell, 14-gaseous substance A, 15-gaseous substance C, 16-residual substance D after decomposition.

### DETAILED DESCRIPTION OF THE PREFERRED EMBODIMENT

The technical solutions in the embodiments of the present invention will be clearly and completely described with reference to the drawings of the following embodiments of the present invention. Obviously, the described embodiments are only a part of all embodiments of the present invention. Based on the embodiments of the present invention, all other embodiments obtained by a person of ordinary skill in the art without creative efforts shall fall within the protection scope of the present invention.

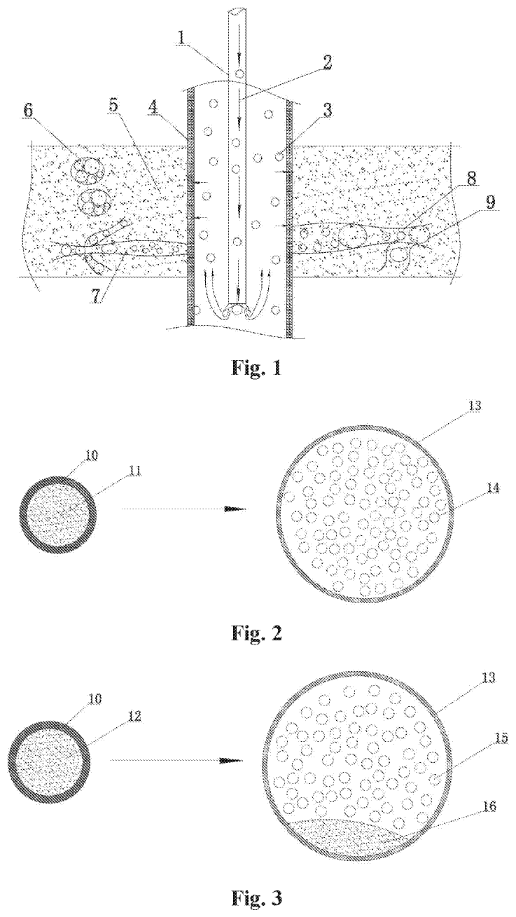

A method and process for plugging formation leakage and improving formation bearing capacity with a capsule-type expansion body based on geothermal heating are provided, whose structure composition and workflow are shown in FIGS. 1-3: a capsule-type expansion body 3 based on geothermal heating, comprising: a capsule shell, and a liquid or/and solid temperature-controlled expansion material; wherein after being prepared on the ground, the capsule-type expansion body circulates with the drilling fluid or gas circulating medium 2 in a drill string 1 and enters fractures and pores of a formation at a long distance around a well under a pressure difference. The formation fractures and pores are mainly divided into formation fractures 6, small fractures 7 and large fractures 8. The capsule-type expansion body 3 expands rapidly and greatly after being heated to a certain temperature by geothermal heat, and elastic deformation adaptively plugs various types of leakage formations 5 and improvs the formation bearing capacity.

The capsule-type expansion body 3 is composed of a shell and a gasification type or a chemical reaction type material, and the shell is a degradable material with strong alkali resistance and expandability, and has large elastic deformation. The capsule-type expansion body 3 can enter deeper formation fractures and pores relative to the well wall, thereby avoiding plugging failure of the well wall as the drilling fluid pressure fluctuates, providing a more sustainable and stable plugging effect.

Referring to FIG. 2, the temperature-controlled expansion material a of the capsule-type expansion body 3 is a liquid or solid substance A 11 (such as SiCl₄) at normal temperature and pressure; an expansion principle is a physical gasification or sublimation reaction: A_{(liquid or solid)} 11 ≙A_{(gas)} 14↑; after the geothermal heating, the substance A 14 reaches a gasification or sublimation reaction temperature and transforms to a gas, in such a manner that the capsule-type expansion body 3 undergoes a large volume expansion; the gasification or sublimation reaction temperature of the substance A is relatively low, and is suitable for leakage formations 5 of deep wells with a high temperature (of 80-150° C.).

Referring to FIG. 3, the temperature-controlled expansion material b of the capsule-type expansion body 3 is a solid single substance or mixture B 12 (such as nitrate, basic carbonate, sodium nitrite, ammonium sulfate, ferrous sulfate); an expansion principle is a material decomposition or chemical reaction: B 12 ≙C 15↑+D 16; after the geothermal heating, the substance or mixture B 12 reaches a material decomposition or chemical reaction temperature and releases a large amount of gas C 15, in such a manner that the capsule-type expansion body 3 undergoes large volume expansion; the material decomposition or chemical reaction temperature of the substance or mixture B 12 is relatively high, and is suitable for leakage formations 5 of deep wells with a super-high or ultra-high temperature (of 150-450° C.).

Principles for plugging formation leakage and improving formation bearing capacity are further explained as follows. The capsule-type expansion body 3 accounts for 3%-8% of a volume of the drilling fluid, which circulates with the drilling fluid or the gas circulation medium 2 through the drill string 1 or toiled tubing, in such a manner that the capsule-type expansion body 3 enters formation areas at a long distance around or near a well under a pressure difference. By continuously heating with geothermal heat, the capsule-type expansion body 3 reaches a physical-chemical reaction temperature, so as to rapidly expand a volume of the capsule-type expansion body by 3-10 times, thereby adaptively plugging formation fractures and pores with elastic deformation of the capsule-type expansion body 3.

Application of the present invention is as follows. The capsule-type expansion body 3 is suitable for leakage formations with different geothermal gradients, and can be applied to deep wells, super-deep wells and ultra-deep wells fracture-type, hole-type formation oil-gas wells or geothermal wells with a formation temperature of 80-450° C. The capsule-type expansion bodies with one or composite expansion principles are selected according to formation plugging requirements and geothermal heat. The temperature-controlled expansion materials can be one or two gasification materials that do not undergo a chemical reaction, or a single substance or a mixture that undergoes a chemical reaction at different temperatures. An external diameter of the capsule-type expansion body 3 is 0.1-10 mm. Small-diameter expansion bodies can enter small fractures 7 and plug formations at a long distance. Large-diameter expansion bodies can enter large fractures 8 and formation fractures 6 and plug formations at a long distance. The expansion bodies with different scales of the external diameter can be formulated for effective formation leakage plugging.

Features of reservoir protection are as follows. The capsule-type expansion body shell 10 is made of a degradable material that can be elastically deformed to a large extent, which meets the requirements of plugging and formation bearing capacity improvement during drilling and completion. After production, it will degrade to relieve formation damage. The capsule-type expansion body shell 10 can degrade, rupture and release gas and residual expansion materials after the high formation temperature is sustained for a certain period of time and requirements of well drilling, construction and completion cycles, thereby removing formation plug and restoring formation permeability. During mixing with the drilling fluid 2, the capsule-type expansion body 3 will not deform and will not affect the components of the drilling fluid 2. It is harmlessly compatible with the drilling fluid 2 and does not change drilling processes, and keeps unexpanded while circulating in a wellbore with a relatively low temperature.

In order to more clearly illustrates the method and process of the present invention, embodiments are provided as follows.

### Embodiment 1

For a deep well drilling operation, the geothermal gradient is 2.6° C./100 m. Fracture-type formation leakage occurs in the well section near 3000 m, and the formation temperature is about 100° C. The capsule expansion body 3 of the present invention is intended to be used for plugging. The physical gasification type expansion body of the present invention is selected as an injection plugging material according to a well temperature and characteristics of the leakage formation. Based on reasonable-designed proportion of the plugging material and the drilling fluid (the proportion of the capsule material and the drilling fluid is 3%-5%), on-site equipment is used to prepare a plugging drilling fluid containing the expansion capsule body. After being thoroughly mixed in a tank, the capsule-type expansion body 3 circulates with drilling fluid through drilling fluid pump-water hose-drill pipe-drill collar-drill bit-annulus runner space. Due to rapid large-displacement circulation of the drilling fluid, a temperature of the drilling fluid ejected from the drill bit is usually 20-30° C. lower than an original formation temperature. With additional measures at a wellhead or low-temperature atmospheric environment operations, the temperature will be 30-40° C. lower than the formation temperature, namely a temperature difference of more than 40° C. with the formation. Under such working condition, a physical gasification type expansion body is selected for plugging the formation. According to the temperature difference between the formation and the wellbore drilling fluid, liquid SiCl₄ or Br₂ can be selected as the temperature-controlled material, which vaporizes and rapidly expands when the temperature exceeds 60-70° C. In other words, the SiCl₄ or Br₂ physical gasification type expansion body does not expand during circulating with the drilling fluid, and enters the formation pores and fractures at the 3000 m section with the drilling fluid leakage under a positive pressure difference. When moving in the formation, the formation temperature continuously heats the capsule-type expansion body 3 until a temperature of the expansion body exceeds a gasification temperature, then the SiCl₄ or Br₂ temperature-controlled material vaporizes from a liquid state to a gaseous state, and rapidly expands by 3-10 times. The expanded elastomer plugs the formation pores and fractures. As a large number of expansion bodies accumulate on each other and adaptively deform, they completely fit wall surfaces of the pores and the fractures, wherein fluid flow channels of the fractures and the pores are completely plugged and the leakage formation is effectively plugged, preventing further leakage of the drilling fluid into the formation as well as improving the formation bearing capacity. Because the expanded capsule shell has a certain service life (about half a year), it can continuously plug the formation during the entire drilling and completion process. After that, oil-gas production operation phase begins. High temperature and pressure of the formation are continuously applied to the expansion body for longer than the expected service life, thereby gradually decomposing and rupturing the expanded capsule shell. The encapsulated gas and the capsule shell are discharged from the formation by a pressure difference, and the original fractures restore their connectivity. In this way, the formation can be effectively plugged during the drilling and completion phase, and production can be resumed during the oil-gas production phase.

### Embodiment 2

For complicated situations such as formation leakage or same layer leakage during drilling and completion of super-deep wells and ultra-deep wells, it is assumed that the plugging material needs to be injected in a well section of 6000 m, the formation temperature changes according to a gradient of 3° C./100 m, and a temperature of the leakage formation is about 200° C. After calculation, the wellbore drilling fluid exceeds 140° C. which differs from the formation by 60° C. Therefore, nitrate temperature-controlled materials, which can generate chemical decomposition reactions at 150-200° C. to produce a large amount of gas, can be selected, which means the formation is plugged by a chemically decomposed expansion body. After selecting the expansion body, proportion of the drilling fluid and capsule-type expansion body is designed (usually 5%-8%) to prepare the plugging drilling fluid according to the leakage situation. Similarly, the expansion body will not expand during circulating with the drilling fluid. After being leaked into the formation pores and fractures, the capsule-type expansion body 3 is continuously heated by the formation temperature until exceeding a critical temperature for chemical decomposition, wherein the temperature-controlled material is decomposed from solid to gas, and a large amount of gas prompts a volume of the expanded body to rapidly expand by 3-10 times. The expanded elastomer plugs the formation pores and fractures, and effectively plugs the formation leakage. Similarly, during the oil-gas production operation phase, the expanded capsule shell is decomposed and ruptured, losing its plugging ability, and recovering formation productivity.

Those skilled in the art will understand that, unless otherwise defined, all terms (including technical and scientific terms) used herein have the same meaning as commonly understood by one of ordinary skill in the art to which the present invention belongs. It should also be understood that terms defined in a general dictionary should be understood to have meanings consistent with the meanings in the context of the prior art, and unless defined as such, will not be explained in an idealized or overly formal sense.

Those of ordinary skill in the art can understand that the components in the device according to the embodiments may be distributed in the device as described in the embodiments, or may be correspondingly located in one or more devices different from the embodiments. The components of the above embodiments may be combined into one, or may be further split into multiple sub-components.

Finally, the above embodiments are only used to illustrate rather than limit the technical solutions of the present invention. Although the present invention has been described in detail with reference to the above embodiments, those skilled in the art should understand that the present invention can still be modified or replaced with the equivalent. Such modification and replacement without departing from the spirit and scope of the present invention shall be covered by the scope of claims of the present invention.

What is claimed is:

1. A capsule-type expansion body based on geothermal heating, comprising:
a capsule shell; and
a liquid or/and solid temperature-controlled expansion material;
wherein the capsule shell is a capsule-type expansion body material with strong alkali resistance;
the liquid or/and solid temperature-controlled expansion material is a temperature-controlled expansion material a or/and a temperature-controlled expansion material b.

2. The capsule-type expansion body, as recited in claim 1, wherein the liquid or/anal solid temperature-controlled expansion material is the temperature-controlled expansion material a, which is a liquid or solid substance A at normal temperature and pressure; an expansion principle is a physical gasification or sublimation reaction: A_{(liquid or solid)}≙A_{(gas)}↑; after the geothermal heating, the substance A reaches a gasification or sublimation reaction temperature and transforms to a gas, in such a manner that the capsule-type expansion body undergoes a large volume expansion; the gasification or sublimation reaction temperature of the substance A is relatively low, and is suitable for leakage formations of deep wells with a high temperature of 80-150° C.

3. The capsule-type expansion body, as recited in claim 1, wherein the liquid or/and solid temperature-controlled expansion material is the temperature-controlled expansion material b, which is a solid single substance or mixture B; an expansion principle is a material decomposition or chemical reaction: B≙C↑+D; after the geothermal heating, the substance or mixture B reaches a material decomposition or chemical reaction temperature and releases a large amount of gas C, in such a manner that the capsule-type expansion body undergoes large volume expansion; the material decomposition or chemical reaction temperature of the substance or mixture B is relatively high, and is suitable for leakage formations of deep wells with a super-high or ultra-high temperature of 150-450° C.

4. The capsule-type expansion body, as recited in claim 1, wherein an external diameter of the capsule-type expansion body is 0.1-10 mm.

5. A method for plugging formation leakage and improving formation bearing capacity with a capsule-type expansion body as recited in claim 1, comprising steps of: when the formation leakage occurs, mixing the capsule-type expansion body with a drilling fluid or a gas circulation medium according to a proportion; circulating the capsule-type expansion body in a drill string with the drilling fluid or the gas circulation medium, in such a manner that the capsule-type expansion body enters fractures and pores of a formation at a long distance around a well under a pressure difference; continuously heating the capsule-type expansion body with formation temperature to reach a physical-chemical reaction temperature, so as to rapidly expand a volume of the capsule-type expansion body by 3-10 times; and adaptively plugging various types of leakage formations with elastic deformation of the capsule-type expansion body; thereby improving the formation bearing capacity.

6. The method, as recited in claim 5, wherein the capsule-type expansion body accounts for 3%-8% of a volume of the drilling fluid.
